(19) United States
(12) Patent Application Publication
(10) Pub. No.: US 2023/0390876 A1
(43) Pub. Date: Dec. 7, 2023

(54) ADJUSTABLE WORKPIECE CRADLES FOR A ROBOTIC WELDING SYSTEM

(71) Applicant: Path Robotics, Inc., Columbus, OH (US)

(72) Inventors: Mike Kaldy, Columbus, OH (US); Andrew Ryan Lien, Columbus, OH (US); Stephen Cribb, Galena, OH (US); Greg Firestone, Columbus, OH (US)

(21) Appl. No.: 18/196,040

(22) Filed: May 11, 2023

Related U.S. Application Data
(60) Provisional application No. 63/349,455, filed on Jun. 6, 2022.

(51) Int. Cl. B23K 37/053

(52) U.S. Cl. CPC B23K 37/0538

(57) ABSTRACT

An adjustable workpiece cradle for a welding system includes a support frame, an elongate flexible member coupled to the support frame and extending along a pathway that forms a concave receptacle configured to laterally receive an elongate workpiece for the welding system, and an adjustment module coupled to the flexible member, wherein the adjustment module includes a powertrain configured to selectably adjust the size of the concave receptacle formed by the pathway of the flexible member.

### CROSS-REFERENCE TO RELATED APPLICATIONS

This application claims benefit of U.S. provisional patent application Ser. No. 63/349,455 filed Jun. 6, 2022, and entitled “Adjustable Workpiece Cradles for A Robotic Welding System,” which is hereby incorporated herein by reference in its entirety for all purposes.

### STATEMENT REGARDING FEDERALLY SPONSORED RESEARCH OR DEVELOPMENT

Not applicable.

### BACKGROUND

Robotic welding systems may be employed in a variety of applications for performing welds on workpieces of different configurations. As one example, robotic welding systems may be utilized to perform seam welds on elongate workpieces such as utility poles used to support electric distribution lines of an electric power grid. The elongate workpiece may be laid horizontally on one or more workpiece cradles configured to rotate the workpiece. One or more robotic arms each equipped with a weld head may be positioned along the elongate workpiece for performing the weld. During operation of the robotic welding system, one or more wheels or rollers of the workpiece cradles the elongate workpiece as the one or more robotic arms perform seam welds on the elongate workpiece whereby the one or more robotic arms weld along the entire circumference of the elongate workpiece as the workpiece is cradled by the one or more workpiece cradles.

### BRIEF SUMMARY OF THE DISCLOSURE

An embodiment of an adjustable workpiece cradle for a welding system comprises a support frame, an elongate flexible member coupled to the support frame and extending along a pathway that forms a concave receptacle configured to laterally receive an elongate workpiece for the welding system, and an adjustment module coupled to the flexible member, wherein the adjustment module comprises a powertrain configured to selectably adjust the size of the concave receptacle formed by the pathway of the flexible member. In some embodiments, the workpiece cradle comprises a plurality of rollers coupled to the support frame and to the flexible member at different locations along the length of the flexible member to define the pathway along which the flexible member extends, wherein the plurality of rollers permits a portion of the flexible member to travel longitudinally along the pathway. In some embodiments, the plurality of rollers are each configured to rotate relative to the support frame, and wherein each of the plurality of rollers comprises a plurality of circumferentially spaced teeth to gear the roller to the flexible member. In certain embodiments, the workpiece cradle comprises a retainer coupled to the flexible member at a retained location along the length of the flexible member, wherein relative movement between the support frame and the flexible member is restricted at the retained location of the flexible member. In certain embodiments, the flexible member comprises a roller chain geared to the plurality of gear teeth of each of the plurality of rollers. In some embodiments, the adjustment module comprises a linear drive and a carriage configured to travel along the linear drive adjust the size of the concave receptacle formed by the pathway of the flexible member, and wherein the flexible member extends through the carriage. In some embodiments, the linear drive is configured to convert an output rotation of the powertrain into longitudinal movement of the carriage along the linear drive. In certain embodiments, the carriage comprises a carriage body threadably connected to the linear drive and a carriage roller coupled to the carriage body and which rollably supports the flexible member. In certain embodiments, the flexible member has an open position providing the concave receptacle with a maximum size, and wherein the workpiece cradle comprises a position sensor coupled to the support frame and configured to provide an indication when the flexible member is in the open position. In some embodiments, the workpiece cradle comprises an onboard controller coupled to the powertrain and comprising a control input for activating the powertrain to increase and decrease the size of the concave receptacle. In some embodiments, the workpiece cradle comprises a grounding module for electrically grounding the workpiece, wherein the grounding module comprises a grounding roller configured to maintain electrical contact between the grounding roller and the workpiece as the workpiece is rotated about a longitudinal axis of the workpiece.

An embodiment of a robotic welding system comprises an adjustable workpiece cradle, a headstock connectable to the workpiece by a chuck, the headstock configured to rotate the workpiece about the longitudinal axis of the workpiece when connected to the workpiece by the chuck, a support rail extending from the headstock, a carriage transportable along the support rail, the adjustable workpiece cradle positioned on the carriage, and a robot positionable alongside the support rail and comprising a weld head for performing a welding operation on the workpiece.

An embodiment of a method for performing a welding operation using a welding system comprises (a) inserting a workpiece into an adjustable workpiece cradle of the welding system, whereby the workpiece is received in a concave receptacle formed by a flexible member of the adjustable workpiece cradle, (b) adjusting the size of the concave receptacle formed by the cradle based on a size of the workpiece, and (c) rotating the workpiece about a longitudinal axis of the workpiece as the workpiece is supported by the adjustable workpiece cradle, and welding the workpiece as the workpiece is rotated about its longitudinal axis and is supported by the adjustable workpiece cradle. In some embodiments, (b) comprises adjusting slack in the flexible member by an adjustment module of the adjustable workpiece cradle. In some embodiments, the size of the workpiece comprises an outer diameter of the workpiece. In certain embodiments, (b) comprises (b1) activating a powertrain of the adjustable workpiece cradle, (b2) rotating a linear drive of the cradle about a longitudinal axis of the linear drive in response to activating the powertrain, and (b3) transporting a carriage of the cradle along the linear drive in response to the rotation of the linear drive, wherein the flexible member extends through the carriage. In certain embodiments (b) comprises adjusting the size of the concave receptacle by a system controller, and (c) comprises rotating the workpiece by the system controller. In some embodiments, the method comprises (e) rolling a grounding roller of the adjustable workpiece cradle along an outer surface of the workpiece to electrically ground the workpiece to the adjustable workpiece cradle as the workpiece rotates about its longitudinal axis.

An embodiment of an adjustable workpiece cradle for a welding system comprises a support frame, an elongate flexible member coupled to the support frame and defining a pathway having a concave receptacle configured to laterally receive an elongate workpiece for the welding system, and a grounding module for electrically grounding the workpiece, wherein the grounding module comprises a grounding roller configured to maintain electrical contact between the grounding roller and the workpiece as the workpiece is rotated about a longitudinal axis of the workpiece. In some embodiments, the grounding module comprises a pivot arm having a first end coupled to the support frame and a second end coupled to the grounding roller and which is pivotable relative to the support frame. In some embodiments the grounding module further comprises a biasing element coupled between the support frame and the pivot joint and configured to bias the pivot arm towards the workpiece when the workpiece is received in the concave receptacle of the cradle. In certain embodiments, the grounding module further comprises a position sensor configured to determine a position of the pivot arm relative to the support frame. In certain embodiments, the grounding module further comprises a biasing element coupled between the grounding roller and the pivot arm and configured to bias the grounding roller relative the pivot arm and towards the workpiece when the workpiece is received in the concave receptacle of the cradle. In some embodiments, the grounding module further comprises a grounding tab electrically connected to the grounding roller, and the adjustable workpiece cradle further comprises a junction block positioned on the support frame and electrically connected to the grounding tab of the grounding module. In some embodiments, the grounding module comprises a body, the grounding roller, and an axle coupled to both the body and the grounding roller and electrically connected to the grounding roller.

An embodiment of a robotic welding system comprises an adjustable workpiece cradle, a headstock connectable to the workpiece by a chuck, the headstock configured to rotate the workpiece about the longitudinal axis of the workpiece when connected to the workpiece by the chuck, a support rail extending from the headstock, a carriage transportable along the support rail, the adjustable workpiece cradle positioned on the carriage, a robot positionable alongside the support rail and comprising a weld head for performing a welding operation on the workpiece.

### BRIEF DESCRIPTION OF THE DRAWINGS

For a detailed description of various exemplary embodiments, reference will now be made to the accompanying drawings in which:

FIG. 1 is a plan view of an embodiment of a robotic welding system;

FIG. 2 is a zoomed-in, perspective view of the robotic welding system of FIG. 1;

FIG. 3 is a perspective view of an embodiment of an adjustable workpiece cradle of the robotic welding system of FIG. 1;

FIG. 4 is a side view of the adjustable workpiece cradle of FIG. 3;

FIG. 5 is a front view of an embodiment of a flexible support assembly of the adjustable workpiece cradle of FIG. 3;

FIG. 6 is a top view of the flexible support assembly of FIG. 5;

FIG. 7 is a top view of the flexible support assembly of FIG. 5;

FIG. 8 is a side cross-sectional view of an embodiment of an adjustment module of the adjustable workpiece cradle of FIG. 3;

FIG. 9 is a perspective view of another embodiment of an adjustable workpiece cradle;

FIG. 10 is a front view of the adjustable workpiece cradle of FIG. 9;

FIG. 11 is a perspective view of an embodiment of a grounding module of the adjustable workpiece cradle of FIG. 9;

FIG. 12 is a front view of the grounding module of FIG. 11; and

FIG. 13 is a block diagram of an embodiment of a method for performing a welding operation using a welding system.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form, and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

As previously described, robotic welding systems may be utilized to perform different types of welds on varying types of workpieces. One example are robotic welding systems are systems utilized to weld elongate workpieces such as utility poles and other tubular structures. Conventional robotic welding systems typically employ conventional workpiece cradles having generally circular rolling elements (e.g., wheels or rollers) which contact and roll the workpiece about a longitudinal axis thereof such that one or more robotic arms may perform seam welds along the entire circumference of the elongate workpiece. Typically, the relative position of the rolling elements must be manually adjusted (e.g., by manually removing one or more threaded fasteners) by an operator of the welding system to permit the rolling elements to support a workpiece of a size that varies from the last workpiece supported by the rolling elements. Thus, the time required to perform the welding operation may be extended to allow for the adjustment of each of the conventional workpiece cradles of the welding system. Additionally, manually adjusting the relative position of the rolling elements may be hazardous for the operator of the welding system. Further, even when adjusted to the desired relative positions, the rolling elements of conventional workpiece cradles may fail to maintain the workpiece in a stable orientation as the workpiece is rotated about its longitudinal axis by a headstock of the welding system. Instead, the workpiece may tend to bounce on or otherwise move relative to the rolling elements.

Accordingly, embodiments of robotic welding systems having one or more adjustable workpiece cradles are disclosed herein. The adjustable workpiece cradles disclosed herein each include an elongate flexible member or conduit which defines a concave receptacle along its length for receiving one or more workpieces of varying size (e.g., outer diameter). The receptacles of the adjustable workpiece cradles described herein may be adjusted through a powered adjustment module via an operator operating a control input or by an automated system controller. Particularly, the adjustment module may include a powertrain and a linear drive driven by the powertrain to increase or decrease the size of the receptacle by adjusting slack in the flexible member of the adjustable workpiece cradle. The flexible members may be supported by rollers one or more of which may be transportable by the linear drive to adjust the size of the receptacle. In some embodiments, a plurality of the adjustable workpiece cradles may be positioned along a common track or rail, the plurality of adjustable workpiece cradles transportable along the common rail via a plurality of corresponding cradles upon which the plurality of adjustable workpiece cradles are mounted.

Some embodiments of adjustable workpiece cradles described herein include a grounding module to ground the workpiece to the adjustable workpiece cradle as the workpiece is rotated about its longitudinal axis. For example, the grounding module may include a grounding roller pivotably coupled to a support frame or base of the adjustable workpiece cradle. The grounding module may also include a biasing element to bias the grounding roller into contact with an outer surface of the workpiece. In this configuration, the grounding roller may roll along the outer surface of the workpiece as the workpiece rotates about its longitudinal axis, thereby maintaining electrical contact between the grounding roller and the workpiece. The grounding roller may be electrically connected to a junction block or other mechanism to establish an electrical connection or grounding path between the grounding roller and the support frame of the adjustable workpiece cradle. In some cases, multiple rollers might be used to facilitate accommodations to more complex pole geometries and ensures adequate electrical coupling.

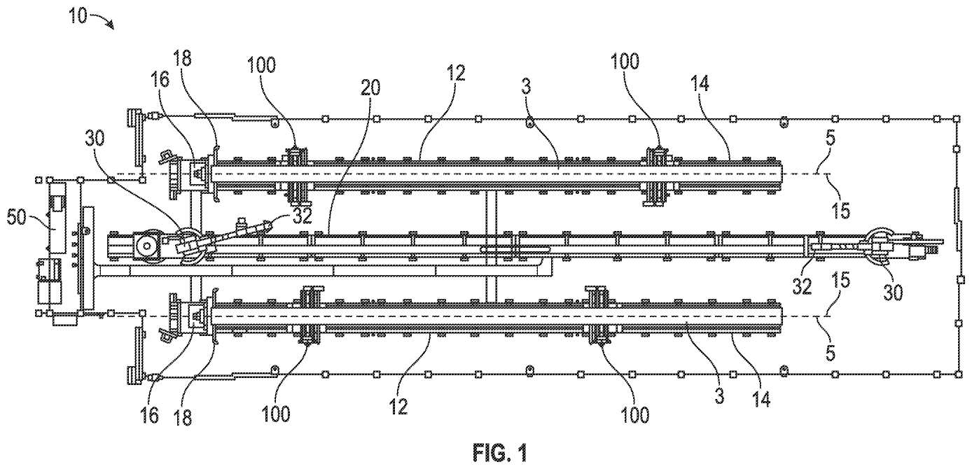

Referring now to FIG. 1, an embodiment of a robotic welding system 10 including one or more adjustable workpiece cradles 100 is shown. In this exemplary embodiment, robotic welding system 10 generally includes a pair of support structures 12, a central track 20, a pair of robotic arms 30 transportable along the central track 20, a system controller 50 for controlling the operation of robotic arms 30 and/or other components of robotic welding system 10, and a plurality of adjustable workpiece cradles 100 transportable along the pair of support structures 12. It may be understood that the number of workpiece cradles, support structures 12, robotic arms 30, and tracks 20 may vary in other embodiments. Moreover, in some embodiments, robotic arms 30 may not be moveably supported along a track and instead may be stationary relative to the ground.

A pair of the workpiece cradles 100 of robotic welding system 10 are coupled to each of the support structures 12. A workpiece 3 may be physically supported on one or each of the support structures 12 of robotic welding system 10 in a horizontal disposition whereby a central or longitudinal axis 5 of the workpiece 3 extends substantially laterally or horizontally relative to the ground. Workpieces 3 are elongate and tubular in configuration and may comprise, for example, a utility pole. It may be understood that in other embodiments the configuration of workpieces 3 may vary from that shown in FIG. 1.

Central track 20 allows for the transportation of robotic arms 30 along central track 20 so that robotic arms 30 may engage one or both of workpieces 3 shown in FIG. 1 at various locations along the longitudinal length of workpieces 3. Central track 20 may comprise one or more servos more motors (not shown in FIG. 1) configured to transport robotic arms 30 to desired locations along the central track 20. Additionally, the motors or other devices utilized for transporting robotic arms 30 along central track 20 may be operated by the system controller 50 of robotic welding system 10.

Robotic arms 30 of robotic welding system 10 comprise one or more pivot arms extending between a first or proximal end mounted to the central track 20 and a second or distal end opposite the proximal end. Additionally, each robotic arm 30 comprises a weld head 32 located at the distal end of the robotic arm 30. Weld head 32 comprises various components for performing a welding operation including a torch and/or other equipment. While in this exemplary embodiment robotic arm 30 comprises weld head 32, in other embodiments, various other types of tools may be attached to the distal end of each robotic arm 30. For example, in other embodiments, instead of or in addition to weld head 32, one or more of the robotic arms 30 of system 10 may comprise a cutting tool, a drill, a gripper, a grinder, and/or other tools.

As described above, support structures 12 physically support the workpieces 3 in a horizontal orientation. In this exemplary embodiment, each support structure 12 generally includes an elongate support rail 14 extending along a central or longitudinal axis 15 oriented generally parallel the central axis 5 of workpiece 3. Additionally, each support structure 12 comprises and a headstock 16 and a chuck 18 each located at an end of the support rail 12. The chuck 18 is configured to connect or attach to an end of the workpiece 3 and the headstock 16 is configured to rotate the workpiece 3 about its central axis 5 in response to activation of the headstock 16. In some embodiments, the activation of the headstock 16 of one or more of the pairs of support structures 12 is controlled by the system controller 50 of robotic welding system 10.

The adjustable workpiece cradles 100 are mounted to the support structures 12 and directly support the workpiece 3, transferring loads from the workpiece 3 to the support structures 12 to which they are coupled. As will be described further herein, workpiece cradles 100 are configured to physically contact and support the workpieces 3 as the workpieces 3 are rotated about their central axes 5. Additionally, workpiece cradles 100 are configured to accommodate workpieces 3 of varying diameter or width in a fail-safe manner to maximize the safety of robotic welding system 10.

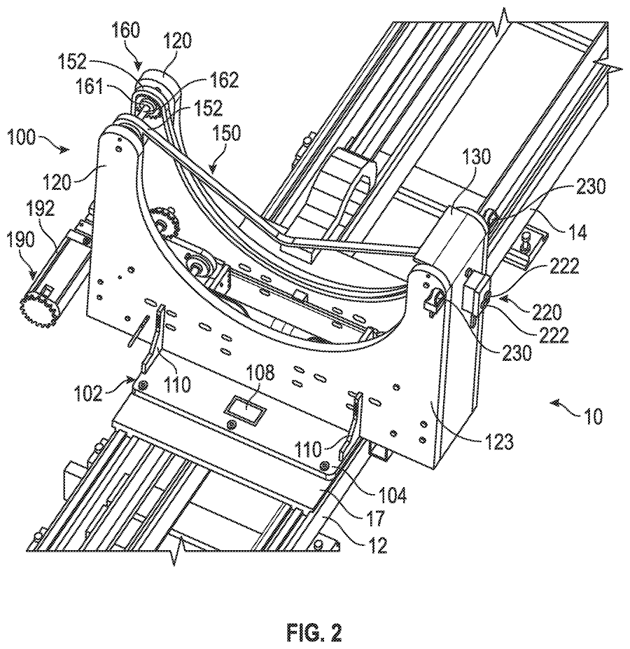

Referring now to FIGS. 1 and 2, in this exemplary embodiment, each support structure 12 may comprise one or more servos or motors (not shown in FIG. 1) for transporting the workpiece cradles 100 along the central axes 15 of support rails 14 to desired locations along the lengths of workpieces 3. For example, workpiece cradles 100 may be mounted onto carriages 17 (shown in FIG. 2) which are transportable along the support rails 14 of support structures 12. However, in other embodiments, workpiece cradles 100 may be stationary relative to the ground. Moreover, it may be understood that in other embodiments, workpiece cradles 100 may be utilized to support workpieces in systems which vary in nature and configuration from the robotic welding system 10 shown in FIG. 1.

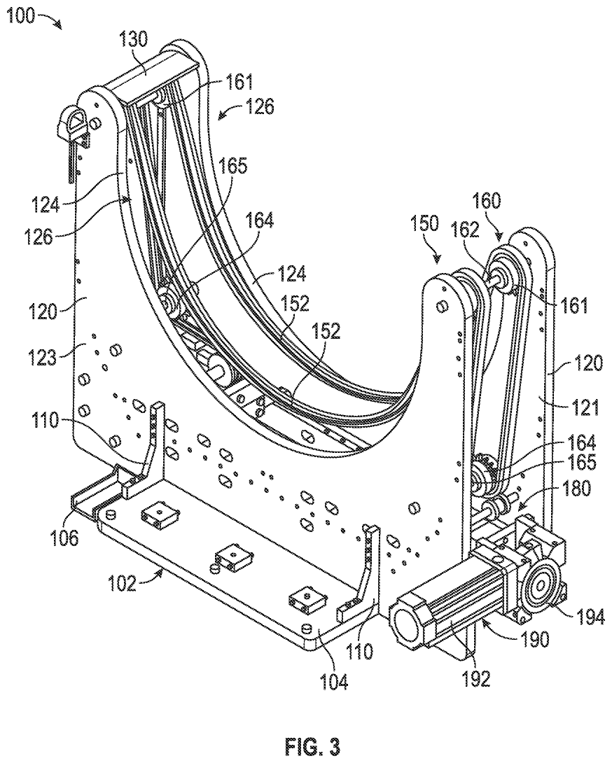

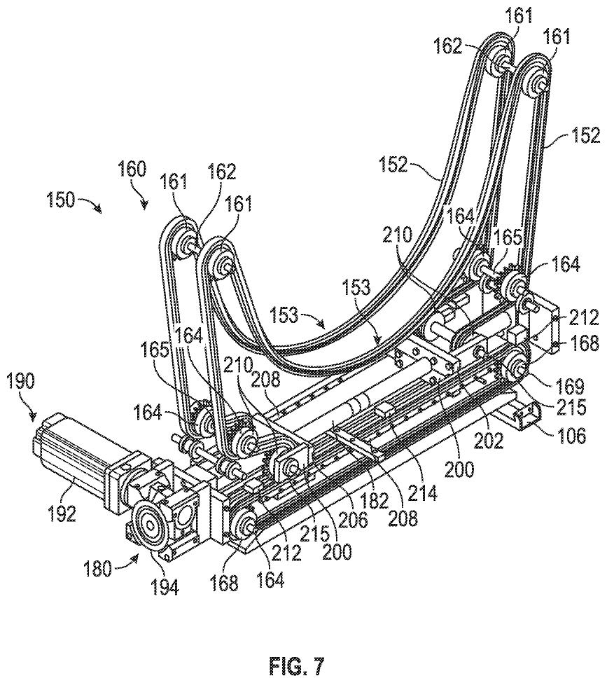

Referring now to FIGS. 2-8, additional views of one of the adjustable workpiece cradles 100 of robotic welding system 10 is shown. In this exemplary embodiment, workpiece cradle 100 generally includes a support frame or base 102, a pair of laterally extending outer frames 120, a flexible support assembly 150 housed between the pair of outer frames 120, and an onboard controller 220 for controlling the operation of workpiece cradle 100 as will be further described herein. In this exemplary embodiment, base 102 comprises a pair of base plates 104 and a plurality of connectors or fasteners 110 connecting the base plates 104 to the outer frames 120. Base plates 104 are generally planar and rectangular in shape each having a bottom surface against which the base plates 104 may mount to the carriage 17 of robotic welding system 10. Base plates 104 additionally each have a top surface, the opposite bottom surface, against which a pair of the connectors 110 are positioned.

Additionally, in this exemplary embodiment, base 102 includes an electrical connector or junction block 108 coupled to one of the base plates 104 of base 102. As will be described further herein, junction block 108 electrically connects to components of workpiece cradle 100 to thereby form a ground path to electrically ground the workpiece cradle 100. The ground path may extend through the junction block 108, base plate 104, and from the base plate 104 to the carriage 17, In this exemplary embodiment, base 102 further includes a retainer 106 defining a channel 107 into which the pair of outer frames 120 are received to locate the pair of outer frames 120 relative to each other. It may be understood that in other embodiments the configuration of base 102 described herein may vary in other embodiments.

In this exemplary embodiment, each outer frame 120 has a proximal side or surface 121, a distal side or surface 123 opposite the proximal side 121, and a saddle-shaped or concave surface 124 which defines a semi-circular channel 126 into which the workpiece 3 is received. The distal side 123 of each outer frame 120 connects to a pair of the connectors 110 to connect the outer frame 120 with one of the base plates 104 in an L-shaped configuration where the outer frame 120 extends at a substantially orthogonal angle relative to the base plate 104. Workpiece cradle 100 additionally includes a guard 130 extending and coupled between the pair of outer frames 120 at one lateral end of the workpiece cradle 100. In this exemplary embodiment, the onboard controller 220 is mounted onto the guard 130; however, it may be understood that in other embodiments the location of onboard controller 150 may vary.

The flexible support assembly 150 of adjustable workpiece cradle 100 comprises a pair of elongate flexible members or guides 152, a roller assembly 160, and an adjustment module 180. In this exemplary embodiment, each flexible member 152 comprises a singular, endless or continuous member such as an endless chain; however, in other embodiments, each flexible member 152 may not comprise an endless member or chain and instead may have a pair of opposed longitudinal ends. While in this exemplary embodiment the flexible support assembly 150 includes a pair of the flexible members 152, in other embodiments, flexible support assembly 150 may include a single flexible member 152 or more than a pair of flexible members 152. Additionally, in this exemplary embodiment, the pair of flexible members 152 comprise a pair of endless chains (e.g., roller chains); however, in other embodiments, flexible members 152 may comprise other types of flexible members such as flexible belts and the like.

Flexible members 152 are configured to contact the workpiece 3 and thereby physically support the workpiece 3 as the workpiece 3 is rotated by a headstock 16 about its central axis 5. As the workpiece 3 rotates, the workpiece 3 physically contacts the pair of flexible members 152 such that the pair of flexible members 152 support the workpiece 3 as the workpiece 3 is rotated about its central axis 5 without binding the workpiece 3 or otherwise applying a substantial resistive torque to the workpiece 3 as it rotates about central axis 5.

In this exemplary embodiment, roller assembly 160 generally includes a set of first or upper rollers 161, a set of second or intermediate rollers 164, and a set of third or lower rollers 168. Roller assembly 160 comprises two pairs of upper rollers 161 which each pair of upper rollers 161 rotatably supported on an upper roller shafts or axles 162 of roller assembly 160 such that upper rollers 161 are permitted to freely rotate or “free spin” about the upper axle 162 to which the upper roller 161 is coupled.

Additionally, roller assembly 160 similarly comprises two pairs of intermediate rollers 164 with each pair of intermediate rollers 164 rotatably supported on an intermediate roller shaft or axle 165 of roller assembly 160 such that intermediate rollers 164 are permitted to free spin about the intermediate axle 165 to which the intermediate roller 164 is coupled. Further, roller assembly 160 comprises two pairs of lower rollers 168 with each pair of lower rollers 168 rotatably supported on a lower roller shaft or axle 169 of roller assembly 160 such that lower rollers 168 are permitted to free spin about the lower axle 169 to which the lower roller 168 is coupled. Opposing longitudinal ends of each of the upper axles 162, intermediate axles 165, and lower axles 169 of roller assembly 160 are connected to the outer frames 120 of workpiece cradle 100, permitting the upper rollers 161, intermediate rollers 164, and lower rollers 168, respectively, to freely rotate relative to the outer frames 120. In this exemplary embodiment, rollers 161, 164, and 168 comprise geared rollers each having a plurality of circumferentially gear teeth geared to the pair of flexible members 152. However, it may be understood that in other embodiments, the number and configuration of rollers 161, 164, and/or 168 may vary in other embodiments. For example, rollers 161, 164, and 168 may not be geared in embodiments where flexible members 152 comprise flexible belts and the like.

Flexible support assembly 150 additionally includes a retention mechanism or retainer 170 configured to prevent flexible members 152 from travelling freely (e.g., in response to frictional contact between workpiece 3 and flexible members 152) travelling along a pathway 153 formed by the flexible member 152 and defined (by controlling the arrangement of flexible member 152) by the roller assembly 160, Pathways 153 extend along the lengths of flexible members 152. Retainer 170 secures or retains the flexible members 152 to the base 102 of workpiece cradle 100 at retained locations thereof. In this exemplary embodiment, retainer 170 comprises a tray 172 over which the pair of flexible members 152 extend and an elongate bar or clamp 174 under which the pair of flexible members 152 passes. In this configuration, flexible members 152 are clamped against the tray 172 by the clamp 174 at their retained locations, preventing the pair of flexible members 152 from moving relative to the tray 172 (and hence the base 102) at the retained locations thereof.

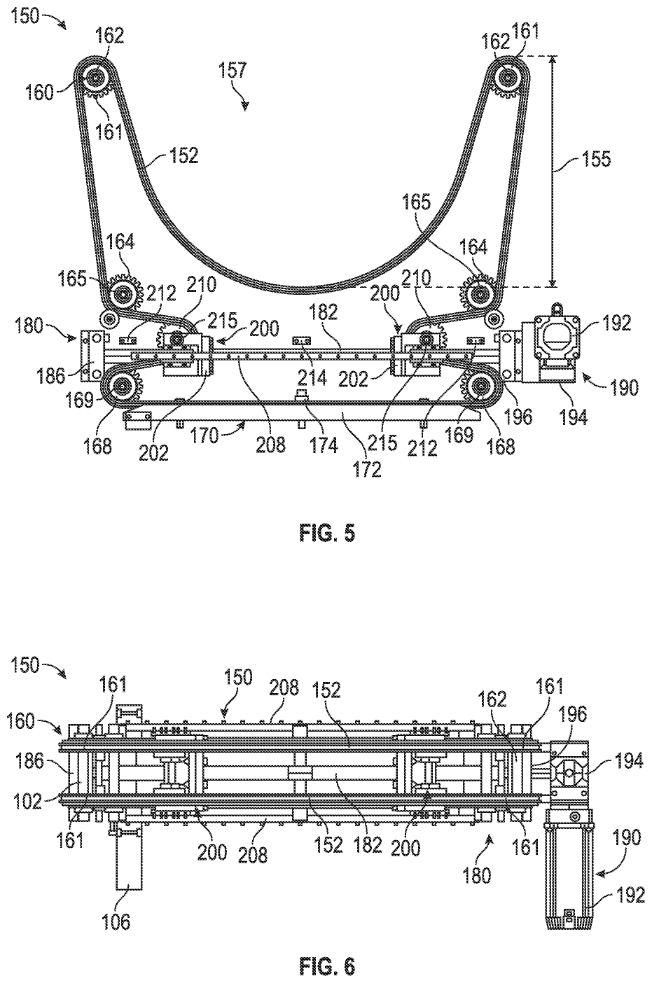

The adjustment module 180 of workpiece cradle 100 adjusts a slack present in flexible members 152 which may be characterized as a depth 155 (shown in FIG. 5) of a semicircular, concave receptacle 157 (shown in FIG. 5) formed by each flexible member 152 along a concave-shaped section of the length of the flexible member 152. Adjustment module 180 is configured to adjust the depth 155 depending on the size (e.g., outer width or diameter) of the workpiece 3 to be supported by the workpiece cradle 100. For example, depth 155 may be decreased by adjustment module 180 to configure the workpiece cradle 100 to support a workpiece 3 having a relatively small outer diameter or width requiring a relatively small concave receptacle 157. Conversely, depth 155 may be increased by adjustment module 180 to configure the workpiece cradle 100 to support a workpiece 3 having a relatively larger outer diameter or width requiring a relatively larger concave receptacle 157.

Adjustment module 180 may be controlled by an operator through onboard controller 220 and/or via the system controller 50 of robotic welding system 10. For example, in some embodiments, flexible support assembly 150 comprises a rest or open configuration in which depth 155 of concave receptacles 157 is at a predefined maximum. With flexible support assembly 150 in the open configuration, the workpiece cradle 100 is configured to receive a workpiece 3 into the concave receptacles 157 defined by flexible members 152. Once the workpiece 3 has been inserted into concave receptacles 157 with flexible support assembly 150 in the open configuration, an operator and/or system controller 50 may activate adjustment module 180 to ensure a desired fit is formed between flexible members 152 and the workpiece 3. Adjustment module 180 may be activated only after a workpiece 3 has been installed in concave receptacles 157 to ensure that the workpiece 3 is fully received into concave receptacles 157 when the workpiece 3 is inserted into the concave receptacles 157.

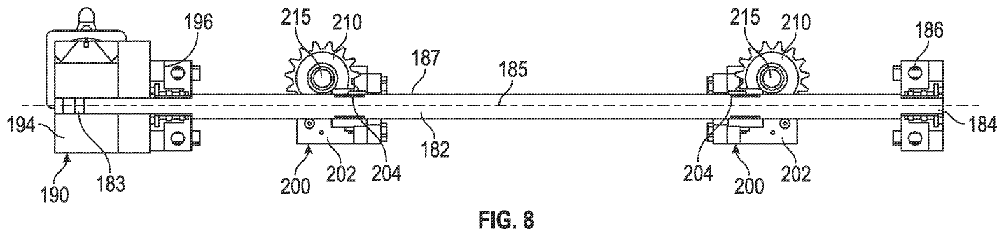

In this exemplary embodiment, adjustment module 180 generally includes a linear drive 182, a drivetrain 190, and a pair of carriages 200 each transportable along the linear drive 182 to adjust the amount of depth 155 and size of concave receptacles 157 defined by flexible members 152. As shown particularly in FIG. 8, linear drive 182 has a central or longitudinal axis 185, first or proximal end 183, and a second or distal end 184 opposite the proximal end 183. The proximal end 183 of linear drive 182 is connected to the drivetrain 190 while the distal end 184 of linear drive 182 is connected to a distal support bearing 186 of the adjustment module 180. Distal support bearing 186 may comprise one or more rolling elements (e.g., one or more balls, rollers) and other components which permit linear drive 182 to rotate relative distal support bearing 186 while transferring radial and/or thrust loads from linear drive 182 to distal support bearing 186. Distal support bearing 186 couples to outer frames 120 and/or shroud 130 to secure the distal supporting bearing 186 to the outer frames 120.

The powertrain 190 of adjustment module 180 is configured to selectably rotate linear drive 182 about its central axis 185 in both a first rotational direction (e.g., clockwise) and a second rotational direction (e.g., counterclockwise) opposite the first rotational direction. In this exemplary embodiment, powertrain 190 comprises a servo or motor 192 (e.g., an electric motor) and a gearbox 194 for transferring rotational motion and torque from an output shaft of motor 192 to the proximal end 183 of linear drive 182. Powertrain 190 additionally includes a proximal support bearing 196 coupled to the linear drive 182 near proximal end 183. Proximal support bearing 196 may be configured similarly as distal support bearing 186 for receiving radial and/or thrust loads from the linear drive 182 as linear drive 182 rotates about its central axis 185.

Carriages 200 interface the adjustment module 180 of workpiece cradle 100 with the flexible support assembly 150 such that rotation of linear drive 182 of powertrain 190 is converted into motion of the flexible members 152 which adjusts or changes the depth 155 of the concave receptacles 157. In this exemplary embodiment, each carriage 200 comprises a carriage body 202 and a pair of carriage rollers 210 coupled to the carriage body 202. Carriage bodies 202 couple carriages 200 to the linear drive 182 whereby activation of powertrain 190 results in the displacement of carriages 200 along central axis 185 of linear drive 182 to thereby adjust the depth 155 of flexible members 152.

In this exemplary embodiment, linear drive 182 comprises an elongate rod having a threaded outer surface also referred to herein as external thread 187 (shown in FIG. 8). Correspondingly, in this exemplary embodiment, the carriage bodies 202 are each internally threaded having an internal thread 204 (shown in FIG. 8) which threadably engages the external thread 182 of linear drive 182. In this configuration, rotation of linear drive 182 about central axis 185 results in linear displacement of carriages 200 along central axis 185 due to the threaded engagement between the external thread 182 of linear drive 182 and the internal threads 204 of carriages 200. It may be understood that in other embodiments the configuration of linear drive 182 and carriages 200 may vary. For example, mechanisms other than threaded engagement may be utilized for displacing carriages 200 or otherwise adjusting the depth 155 of flexible members 152.

The carriage rollers 210 of each carriage 200 are coupled to the carriage body 202 thereof through a carriage shaft 215 which connects to both the carriage body 202 and the pair of carriage rollers 210 of the given carriage 200. The carriage rollers 210 of carriages 200 are permitted to freely rotate or free-spin relative to the carriage body 202 thereof so as to not bind flexible members 152. Carriage rollers 210 may be configured similarly as the rollers 161, 164, and 168 described above and thus may comprise geared rollers each having a plurality of circumferentially gear teeth geared to the pair of flexible members 152.

In this exemplary embodiment, the carriage bodies 202 are guided along central axis 185 (when driven by powertrain 190) by a pair of elongate tracks 208 coupled to the outer frames 120 of workpiece cradle 100. Additionally, a plurality of outer stops 212 and a plurality of inner stops 214 are coupled to the outer frames 120 of workpiece cradle 100 and delimit the range of travel of carriages 200 along the central axis 185 in response to activation of powertrain 190. Particularly, workpiece cradle 100 includes two pairs of outer stops 212 located near the ends 183 and 184 of linear drive 182 and aligned with carriages 200. Additionally, workpiece cradle 100 includes a single pair of inner stops 214 positioned between the pair of carriages 200 and aligned with the carriages 200.

In this configuration, carriages 200 will eventually contact or collide with outer stops 212 as carriages 200 are displaced outwards towards outer stops 212 in response to the activation of powertrain 190, where contact between carriages 200 and outer stops 212 thereby arrests the outward travel of carriages 200. Similarly, carriages 200 will eventually contact or collide with outer stops 212 as carriages 200 are displaced inwardly towards inner stops 214 in response to the activation of powertrain 190, where contact between carriages 200 and inner stops 214 thereby arrests the outward travel of carriages 200. In this manner, outer stops 212 define the maximum depth 155 of flexible members 152 which may be obtained through the activation of powertrain 190 while inner stops 214 define the minimum depth 155 of flexible members 152 which may be obtained through the activation of powertrain 190.

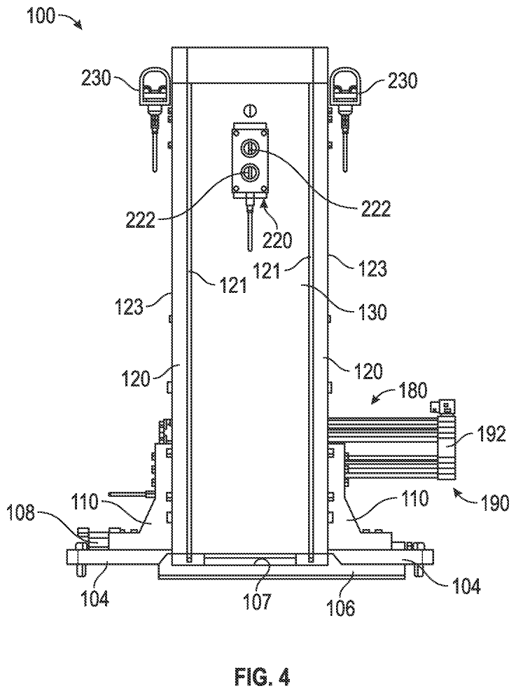

Referring to FIG. 4, the onboard controller 220 of workpiece cradle 100 may be operated by a human operator (or by a system controller such as controller 50) to control the operation of various components of the support 100. In this exemplary embodiment, onboard controller 220 may be operated using one or more input devices 222 of onboard controller 220 which are shown in FIGS. 2-8 as adjustable knobs but may comprise other forms of control inputs such as a keypad or keyboard, a joystick, a mouse.

Once a workpiece 3 has been installed into the concave receptacles 157 of workpiece cradle 100 with flexible support assembly 150 in the open configuration, an operator may engage the one or more input devices 222 to selectably activate the powertrain 190 of workpiece cradle 100 and reduce the depth 155 of flexible members 152 and thereby the size of concave receptacles 157 until the size of concave receptacles 157 corresponds to a size or outer diameter of the workpiece 3. In some instances, the size of the concave receptacle 157 is reduced until it aligns the longitudinal axis 5 of workpiece 3 with a longitudinal axis of the headstock 16. In some embodiments, a first input device 222 of onboard controller 220 may selectably adjust the size of the cavity 157 defined by a first of the flexible members 152 while a second input device 222 of controller 220 may selectably adjust the size of the cavity 157 defined by a second of the flexible members 152. In this manner, the operator may adjust the size of the cavities 157 defined by flexible members 152 to match or correspond to the size (e.g., the outer diameter) of the workpiece 3 to be supported by the workpiece cradle 100. It may also be understood that in some embodiments the onboard controller 220 may be controllable by system controller 50 shown in FIG. 1, and thus may not include input devices 222.

In this exemplary embodiment, workpiece cradle 100 includes a pair of safety stops or buttons 230 in signal communication with the onboard controller 222 or system controller 50. As a safety feature, the operator may be required to continuously press down with their fingers on one or both of the safety stops 230 while powertrain 190 of the workpiece cradle 100 and/or other components of robotic welding system 100 are in current operation. However, workpiece cradle 100 may not include safety stops 230 in other embodiments.

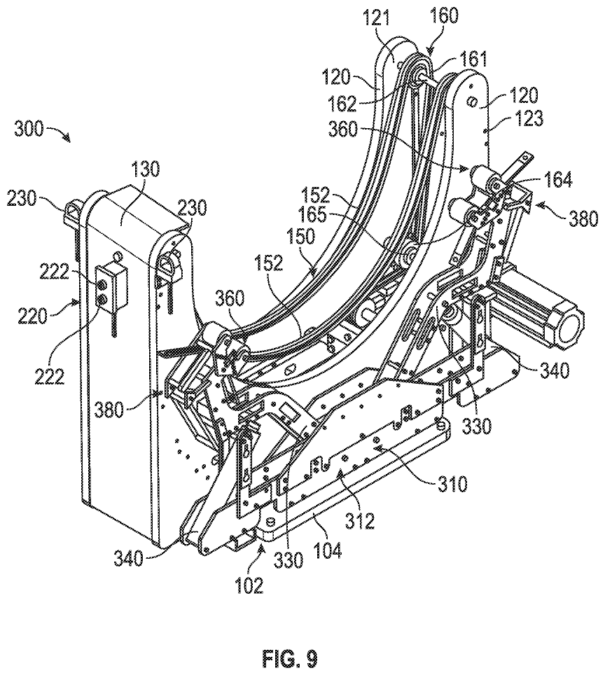

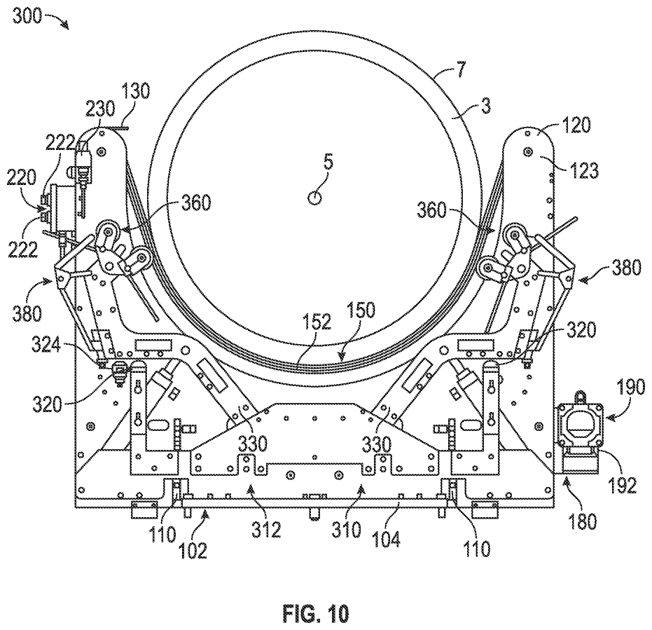

Referring now to FIGS. 9-12, another embodiment of a workpiece cradle 300 is shown. The robotic welding system 10 (as well as other welding systems) may include one of or both of workpiece cradles 100 and 300. Additionally, workpiece cradle 300 may include features in common with workpiece cradle 100 shown in FIGS. 1-8, and shared features are labeled similarly. Particularly, in this exemplary embodiment, workpiece cradle 300 generally includes a grounding module 310 in addition to the components and features of workpiece cradle 100 described above (e.g., base 102, outer frames 120, flexible support assembly 150, etc.).

Grounding module 310 assists with electrically grounding the workpiece 3 through a predefined grounding path extending through the grounding module 310 to a carriage 17 of robotic welding system 10 when the workpiece 3 is supported by the support 300. In this manner, grounding module 310 isolates as much of the workpiece cradle 300 as possible from the grounding path including, for example, the flexible support assembly 150 of support 300. Grounding module 310 provides for a continuous and predictable electrical connection between workpiece cradle 300 and the workpiece 3 as the workpiece 3 is rotated about its axis 5 without the cumbersome requirement of manually repositioning a conventional grounding lug (rendered superfluous by grounding module 310) as the workpiece 3 rotates while a welding operation is performed on the workpiece 3 such as a seam weld.

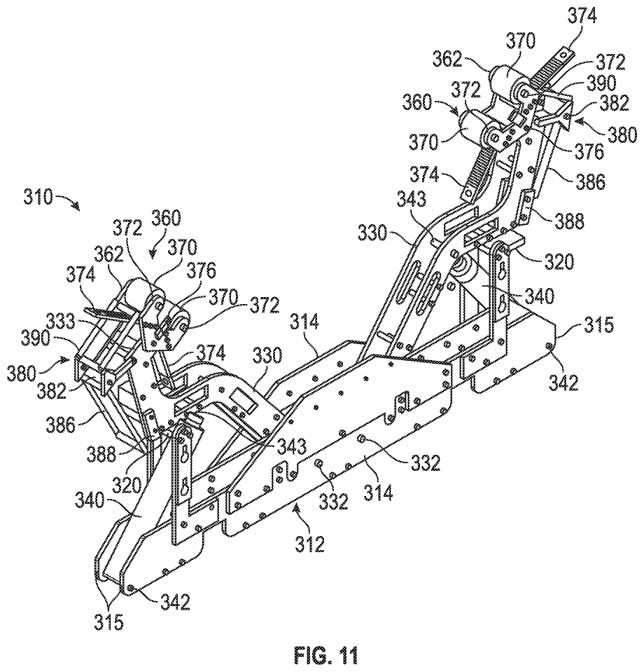

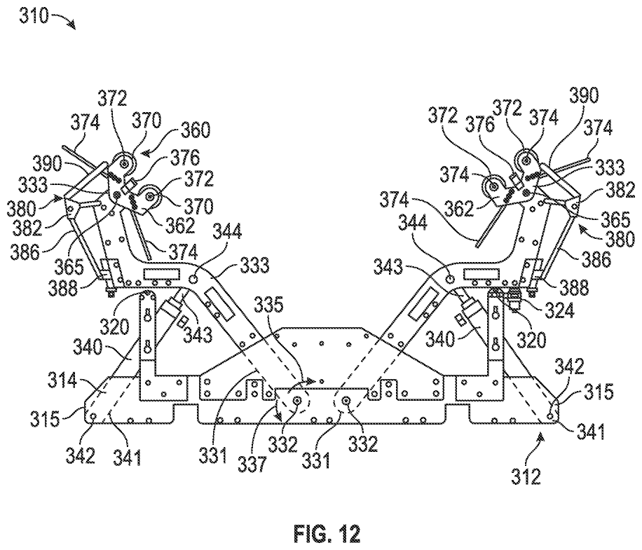

As shown particularly in FIGS. 11 and 12, in this exemplary embodiment, grounding module 310 generally includes a support frame or base 312, a pair of pivot arms 330, and a pair of electrical or grounding connectors 360 which electrically connect the grounding module 310 with the workpiece 3 while at the same time permitting relative rotation between the workpiece 3 and the grounding connectors 360 of grounding module 310. It may be understood that in other embodiments the configuration of grounding module 310 may vary. For example, in other embodiments, grounding module 310 may include only a single pivot arm 330 or more than two pivot arms 330.

Base 312 of grounding module 310 couples or secures grounding module 310 to the base 102 of workpiece cradle 100. In this exemplary embodiment, base 312 is configured to couple to (e.g., via a plurality of fasteners) one of the base plates 104 of base 102; however, it may be understood that base 312 may couple to other components such as to one of the outer frames 120. Base 312 generally includes a pair of outer frames 314 each extending between opposed laterally outer (relative to the central axis 5 of the workpiece 3 when supported by the workpiece cradle 300) ends 315.

Additionally, in this exemplary embodiment, base 312 includes a pair of bump stops 320 coupled to the outer frames 314 and which delimit the travel of pivot arms 330 relative to the base 312, as will be described further herein. Bump stops 320 are oriented in the direction or face the pivot arms 330 and may contact or otherwise engage the pivot arms 330 to prevent the pivot arms 330 from travelling farther in a given direction relative to the base 312. Further, in this exemplary embodiment, a proximal position sensor 324 is coupled to one of the bump stops 320 to monitor a position of one of the pivot arms 330 relative to the bump stop 320. It may be understood that in other embodiments grounding module 310 may comprise a pair of position sensors 324 to monitor both pivot arms 330 while in still other embodiments grounding module 310 may not include a single proximal position sensor 324.

Proximal position sensor 324 may continuously monitor whether or not the pivot arm 330 is currently in contact with the bump stop 320 and/or may continuously monitor a relative distance between the pivot arm 330 and the bump stop 320. In some embodiments, position sensor 320 comprises a proximity sensor such as a Hall effect sensor; however, the configuration of proximal position sensor 324 may vary in other embodiments. Signals produced by the proximal position sensor 324 may be communicated to one of or both of the onboard controller 220 of workpiece cradle 300 and a separate system controller such as system controller 50 described above. For example, an operator of robotic welding system 10 may monitor in real-time from an output device (e.g., a display device) of system controller 50 the relative position of the pivot arm 330 and bump stop 320 and/or whether the pivot arm 330 is currently in contact with the bump stop 320. Contact between pivot arm 330 and bump stop 320 may indicate, depending on the size of the workpiece 3 currently supported by workpiece cradle 300, that the grounding module 310 has fallen out of electrical contact with workpiece 3.

Pivot arms 330 of grounding module 310 are configured to position the grounding connectors 360 of module 310 relative to the workpiece 3 such that continuous electrical contact is maintained between the workpiece 3 and the grounding connectors 360. Given that an outer surface 7 of workpiece 3 may be irregular, pivot arms 330 permit grounding connectors 360 to move and pivot relative to base 312 to account for variations in geometry along the outer surface 7 of workpiece 3 as workpiece 3 rotates relative to the grounding module 310 and workpiece cradle 100.

In this exemplary embodiment, each pivot arm 330 includes a first or proximal end 331 (shown in FIG. 12), and a second or distal end 333 opposite proximal end 331. The proximal ends 331 of pivot arms 330 are pivotably coupled to the outer frames 314 of base 312 by a pair of pivot joints 332 each located near a middle (relative to the outer ends 315) of outer frames 314. In this configuration, pivot joints 332 define pivot axes about which the pivot arms 330 pivot or rotate relative to base 312. Particularly, pivot arms 330 may rotate in a first rotational direction (indicated by arrow 335 in FIG. 12) and a second rotational direction (indicated by arrow 337 in FIG. 12) that is the opposite of the first rotational direction 335.

Grounding module 310 additionally includes a pair of first or proximal biasing elements 340 coupled between the base 312 and the pair of pivot arms 330. Proximal biasing elements 340 bias the pivot arms 330 inwards (in the first rotational direction 335 for the pivot arm 330 indicated in FIG. 12) towards the workpiece 3 when the workpiece 3 is supported by the workpiece cradle 300. In this exemplary embodiment, proximal biasing elements 340 comprise pneumatic cylinders; however, it may be understood that the configuration of proximal biasing elements 340 may vary in other embodiments. For example, in other embodiments, proximal biasing elements 340 may comprise coil springs, gravity assisted washers, etc. Each proximal biasing element 340 comprises a first or proximal end 341 (shown in FIG. 12) coupled to the outer frames 314 of base 312 at a first or proximal pivot joint 342, and a second or distal end 343 coupled to a corresponding pivot arm 330 at a second or distal pivot joint 344. Proximal pivot joints 342 are located near the outer ends 315 of outer frames 314 while the distal pivot joints 344 are located distal from both ends 331 and 333 of the pivot arms 330.

Grounding connectors 360 are pivotably or articulating connected to the distal ends 333 of pivot arms 330 to permit grounding connectors 360 to move and pivot relative to both pivot arms 330 and the base 312 of grounding module 310. In this manner, a desired, tangential orientation may be maintained between the grounding connectors 360 and the outer surface 7 of workpiece 3 to maintain electrical contact between grounding connectors 360 and workpiece 3 as workpiece 3 rotates about central axis 5. In this exemplary embodiment, grounding connectors 360 generally include a connector body 362 and a pair of grounding rollers 370 coupled to the connector body 362 by a corresponding pair of roller shafts or axles 372 which permit the grounding rollers 370 to freely spin or rotate about axles 372 relative to the connector body 362. Connector body 362 is connected to a given pivot arm 330 at a distal pivot joint 365 located near the distal end 333 of the pivot joint 365, thereby permitting the grounding connector 360 to pivot or rotate about the pivot joint 365 relative to the pivot arm 330.

In this exemplary embodiment, the axles 372 of each grounding connector 360 are coupled to one or more grounding tabs or straps 374 of the grounding connector 360. Grounding rollers 370, axles 372, and grounding tabs 374 are each formed from and comprise an electrically conductive material such as copper and the like. An electrical grounding pathway is formed which extends from the grounding rollers 370 to the axles 372 via contact therebetween, and from the axles 372 to the grounding tabs 374 via contact therebetween. Grounding tables 374 may be connected via one or more electrical signal conductors or cables (not shown in FIGS. 9-12) to the junction block 108 of workpiece cradle 100 to electrically connect the grounding tabs 374 to the base 102 of support 300.

In this exemplary embodiment, each grounding connector 360 includes a second or distal position sensor 376 that is positioned between the pair of grounding rollers 376 and oriented in the direction of the workpiece 3 to be supported by the workpiece cradle 300. Distal position sensor 376 may also be referred to herein as contact sensor 376. The distal position sensor 376 monitors a position of the grounding connector 360 relative to the workpiece 3 when the workpiece 3 is supported by the workpiece cradle 300. Particularly, distal position sensor 376 may continuously monitor for whether the grounding connector 360 is currently electrically connected to the workpiece 3 in response to physical contact between the outer surface 7 of the workpiece 3 and the grounding rollers 370 of grounding connector 360. Similar to the proximal position sensor 324 described above, in some embodiments, distal position sensor 376 comprises a proximity sensor such as a Hall effect sensor; however, the configuration of distal position sensor 376 may vary in other embodiments. Signals produced by the distal position sensor 376 may be communicated to one of or both of the onboard controller 220 of workpiece cradle 300 and a separate system controller such as system controller 50 described above. This may permit an operator of robotic welding system 10 to continuously monitor (e.g., via an output device of system controller 50) whether a given workpiece cradle 300 is in current electrical contact with a given workpiece 3.

Grounding mechanism 310 additionally includes a pair of distal biasing elements 380 associated with the pair of corresponding pivot arms 330 and grounding connectors 360. Distal biasing elements 380 are configured to bias the grounding connectors 360 outwards in the opposite rotational direction of proximal biasing elements 340. In this manner, an inner grounding roller 370 of each grounding connector 360 is biased by distal biasing elements 380 away from the base 312 while an outer grounding roller 370 of each grounding connector 360 is biased by distal biasing elements 380 towards the base 312. This prevents a workpiece 3 from landing against only the outer grounding rollers 370 of grounding connectors 360 when the workpiece 3 is installed into the receptacles 374 of the workpiece cradle 300 and instead ensures that the grounding connector 360 is oriented tangentially with respect to the outer surface 7 of workpiece 3 with each grounding roller 370 of the grounding connector 360 in electrical contact with the workpiece 3.

In this exemplary embodiment, each distal biasing element 380 generally includes a rocker arm 382, a first or proximal pair of springs 386, and a second or distal pair of springs 390. Rocker arms 382 of distal biasing elements 380 are pivotably connected to the pivot arms 330 at locations near the distal ends 333 of pivot arms 330. Proximal springs 386 are coupled between the rocker arms 382 and the pivot arms 330 to thereby bias the rocker arms 382 in the direction of proximal springs 386. Conversely, distal springs 390 are coupled between rocker arms 382 and the connector bodies 362 of grounding connectors 360, biasing rocker arms 382 in the opposing direction of distal springs 390. In this exemplary embodiment, springs 386 and 390 comprise coil springs; however, the configuration of springs 386 and 390 may vary in other embodiments. It may also be understood that the configuration of each distal biasing element 380 itself may vary in configuration in other embodiments. For example, in other embodiments distal biasing elements 380 may comprise pneumatic cylinders or other devices for applying a biasing force against the grounding connectors 360.

In this configuration, distal springs 390 of the distal biasing element 380 apply a biasing force against the corresponding grounding connector 360 in the direction of rocker arm 382 to ensure that grounding connector 360 obtain and remains in a tangential orientation relative to the workpiece 3 as described above. The amount of biasing force imparted to the grounding connector 360 by distal springs 390 may be adjusted by adjusting the tension of proximal springs 386. Particularly, in this exemplary embodiment, proximal springs 386 are connected to the corresponding pivot arm 330 by a sliding or adjustment plate 388 coupled to the pivot arm 330. Adjustment plate 388 is releasably coupled to the pivot arm 330 and tension in proximal springs 386 may be adjusted by adjusting the position of adjustment plate 388 relative to pivot arm 330.

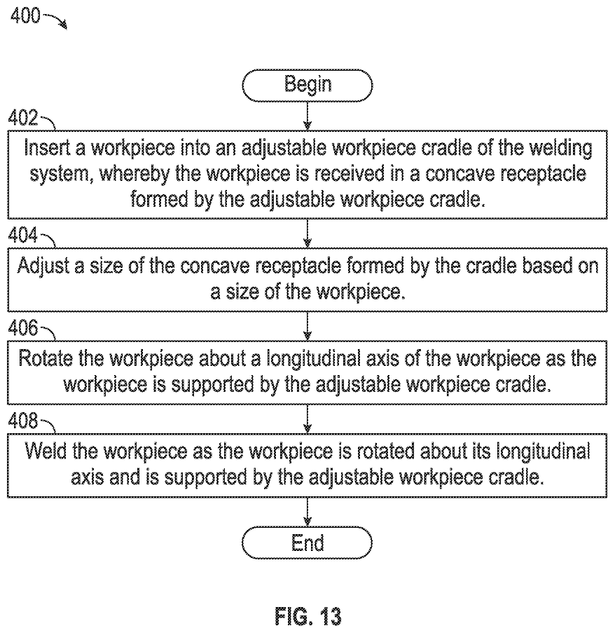

Referring to FIG. 13, an embodiment of a method 400 for performing a welding operation by a welding system is shown. Initially, method 400 begins at block 402 by inserting a workpiece into an adjustable workpiece cradle of the welding system, whereby the workpiece is received in a concave receptacle formed by the adjustable workpiece cradle. In some embodiments, block 402 comprises inserting the workpiece 3 shown in FIG. 1 into the adjustable workpiece cradle 100 of the robotic welding system 10 also shown in FIG. 1 whereby the workpiece 3 is received in a concave receptacle 157 (shown in FIG. 5) formed by the cradle 100. At block 404, method 400 comprises adjusting a size of the concave receptacle formed by the cradle based on a size of the workpiece. In some embodiments, block 404 comprises adjusting a size of a concave receptacle 157 of the workpiece cradle 100 based on a size of the workpiece 3. For example, the size of concave receptacle 157 may be adjusted (e.g., made smaller) based on an outer diameter or width of the workpiece 3. In some instances, the size of the concave receptacle 157 may be reduced until it corresponds to the size of the workpiece 3 such as the size of the outer diameter of the workpiece 3. In some instances, the size of the concave receptacle 157 is reduced until it aligns the longitudinal axis 5 of workpiece 3 with a longitudinal axis of the headstock 16.

At block 406, method 400 comprises rotating the workpiece about a longitudinal axis of the workpiece as the workpiece is supported by the adjustable workpiece cradle. In some embodiments, block 406 comprises rotating the workpiece 3 about its longitudinal axis 5 as the workpiece 3 is supported by the adjustable workpiece cradle 100. In some embodiments, the workpiece 3 is positioned by a plurality of the adjustable workpiece cradles 3 adjustably positioned at different locations along the length of the workpiece 3. At block 408, method 400 comprises welding the workpiece as the workpiece is rotated about its longitudinal axis and is supported by the adjustable workpiece cradle. In some embodiments, block 408 comprises welding the workpiece 3 (e.g., performing a seam weld on the workpiece 3 using a robotic arm 30 shown in FIG. 1) as the workpiece 3 is rotated about its longitudinal axis 5 and is supported by the adjustable workpiece cradle 100.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. An adjustable workpiece cradle for a welding system, the workpiece cradle comprising:
a support frame;
an elongate flexible member coupled to the support frame and extending along a pathway that forms a concave receptacle configured to laterally receive an elongate workpiece for the welding system; and
an adjustment module coupled to the flexible member, wherein the adjustment module comprises a powertrain configured to selectably adjust the size of the concave receptacle formed by the pathway of the flexible member.

2. The workpiece cradle of claim 1, further comprising:
a plurality of rollers coupled to the support frame and to the flexible member at different locations along the length of the flexible member to define the pathway along which the flexible member extends, wherein the plurality of rollers permits a portion of the flexible member to travel longitudinally along the pathway.

3. The adjustable workpiece cradle of claim 2, wherein the plurality of rollers are each configured to rotate relative to the support frame, and wherein each of the plurality of rollers comprises a plurality of circumferentially spaced teeth to gear the roller to the flexible member.

4. The adjustable workpiece cradle of claim 2, further comprising a retainer coupled to the flexible member at a retained location along the length of the flexible member, wherein relative movement between the support frame and the flexible member is restricted at the retained location of the flexible member.

5. The adjustable workpiece cradle of claim 4, wherein the flexible member comprises a roller chain geared to the plurality of gear teeth of each of the plurality of rollers.

6. The adjustable workpiece cradle of claim 1, wherein the adjustment module comprises a linear drive and a carriage configured to travel along the linear drive adjust the size of the concave receptacle formed by the pathway of the flexible member, and wherein the flexible member extends through the carriage.

7. The adjustable workpiece cradle of claim 6, wherein the linear drive is configured to convert an output rotation of the powertrain into longitudinal movement of the carriage along the linear drive.

8. The adjustable workpiece cradle of claim 6, wherein the carriage comprises a carriage body threadably connected to the linear drive and a carriage roller coupled to the carriage body and which rollably supports the flexible member.

9. The adjustable workpiece cradle of claim 1, wherein the flexible member has an open position providing the concave receptacle with a maximum size, and wherein the workpiece cradle comprises a position sensor coupled to the support frame and configured to provide an indication when the flexible member is in the open position.

10. The adjustable workpiece cradle of claim 1, further comprising an onboard controller coupled to the powertrain and comprising a control input for activating the powertrain to increase and decrease the size of the concave receptacle.

11. The adjustable workpiece cradle of claim 1, further comprising:
a grounding module for electrically grounding the workpiece, wherein the grounding module comprises a grounding roller configured to maintain electrical contact between the grounding roller and the workpiece as the workpiece is rotated about a longitudinal axis of the workpiece.

12. A robotic welding system comprising the adjustable workpiece cradle of claim 1, the robotic welding system comprising:
a headstock connectable to the workpiece by a chuck, the headstock configured to rotate the workpiece about the longitudinal axis of the workpiece when connected to the workpiece by the chuck;
a support rail extending from the headstock;
a carriage transportable along the support rail, the adjustable workpiece cradle positioned on the carriage;
a robot positionable alongside the support rail and comprising a weld head for performing a welding operation on the workpiece.

13. A method for performing a welding operation using a welding system, method comprising:
(a) inserting a workpiece into an adjustable workpiece cradle of the welding system, whereby the workpiece is received in a concave receptacle formed by a flexible member of the adjustable workpiece cradle;
(b) adjusting the size of the concave receptacle formed by the cradle based on a size of the workpiece; and
(c) rotating the workpiece about a longitudinal axis of the workpiece as the workpiece is supported by the adjustable workpiece cradle; and
(d) welding the workpiece as the workpiece is rotated about its longitudinal axis and is supported by the adjustable workpiece cradle.

14. The method of claim 13, wherein (b) comprises adjusting slack in the flexible member by an adjustment module of the adjustable workpiece cradle.

15. The method of claim 13, wherein the size of the workpiece comprises an outer diameter of the workpiece.

16. The method of claim 13, wherein (b) comprises:
(b1) activating a powertrain of the adjustable workpiece cradle;
(b2) rotating a linear drive of the cradle about a longitudinal axis of the linear drive in response to activating the powertrain; and
(b3) transporting a carriage of the cradle along the linear drive in response to the rotation of the linear drive, wherein the flexible member extends through the carriage.

17. The method of claim 13, wherein:
(b) comprises adjusting the size of the concave receptacle by a system controller; and
(c) comprises rotating the workpiece by the system controller.

18. The method of claim 13, further comprising:
(e) rolling a grounding roller of the adjustable workpiece cradle along an outer surface of the workpiece to electrically ground the workpiece to the adjustable workpiece cradle as the workpiece rotates about its longitudinal axis.

19. An adjustable workpiece cradle for a welding system, the workpiece cradle comprising:
a support frame;
an elongate flexible member coupled to the support frame and defining a pathway having a concave receptacle configured to laterally receive an elongate workpiece for the welding system; and
a grounding module for electrically grounding the workpiece, wherein the grounding module comprises a grounding roller configured to maintain electrical contact between the grounding roller and the workpiece as the workpiece is rotated about a longitudinal axis of the workpiece.

20. The adjustable workpiece cradle of claim 19, wherein the grounding module comprises a pivot arm having a first end coupled to the support frame and a second end coupled to the grounding roller and which is pivotable relative to the support frame.

21. The adjustable workpiece cradle of claim 20, wherein the grounding module further comprises a biasing element coupled between the support frame and the pivot joint and configured to bias the pivot arm towards the workpiece when the workpiece is received in the concave receptacle of the cradle.

22. The adjustable workpiece cradle of claim 20, wherein the grounding module further comprises a position sensor configured to determine a position of the pivot arm relative to the support frame.

23. The adjustable workpiece cradle of claim 20, wherein the grounding module further comprises a biasing element coupled between the grounding roller and the pivot arm and configured to bias the grounding roller relative the pivot arm and towards the workpiece when the workpiece is received in the concave receptacle of the cradle.

24. The adjustable workpiece cradle of claim 19, wherein:
the grounding module further comprises a grounding tab electrically connected to the grounding roller; and
the adjustable workpiece cradle further comprises a junction block positioned on the support frame and electrically connected to the grounding tab of the grounding module.

25. The adjustable workpiece cradle of claim 19, wherein the grounding module comprises a body, the grounding roller, and an axle coupled to both the body and the grounding roller and electrically connected to the grounding roller.

26. A robotic welding system comprising the adjustable workpiece cradle of claim 10, the robotic welding system comprising:
a headstock connectable to the workpiece by a chuck, the headstock configured to rotate the workpiece about the longitudinal axis of the workpiece when connected to the workpiece by the chuck;
a support rail extending from the headstock;
a carriage transportable along the support rail, the adjustable workpiece cradle positioned on the carriage;
a robot positionable alongside the support rail and comprising a weld head for performing a welding operation on the workpiece.
